(19) United States
(12) Patent Application Publication
(10) Pub. No.: US 2014/0122125 A1
(43) Pub. Date: May 1, 2014

(54) SYSTEM AND METHOD FOR PROVIDING REMOTE MEDICAL CONSULTING BETWEEN A PATIENT AND A PHYSICIAN

(71) Applicant: Logimed LLC, Burr Ridge, IL (US)

(72) Inventors: Prashant Deshpande, Burr Ridge, IL (US); Ajay Bhagwat, Burr Ridge, IL (US)

(21) Appl. No.: 14/065,335

(22) Filed: Oct. 28, 2013

Related U.S. Application Data
(60) Provisional application No. 61/719,089, filed on Oct. 26, 2012.

(51) Int. Cl. G06F 19/00; G06Q 30/04; G06Q 50/24

(52) U.S. Cl. CPC G06F 19/3418; G06Q 50/24; G06Q 30/04
USPC 705/3; 705/2

(57) ABSTRACT

The present invention relates to a system and method for providing remote medical consulting between a patient and a physician. The system comprises a patient device 102, a physician device 104, and a cloud server 108 wherein the patient device 102, the cloud server 108 and the physician device 104 are connected through a communication network 106. The patient device 102 is configured to receive data from the patient using at least one diagnostic sensor and send the data to the cloud server 108 through the communication network 106. The physician device 104 configured to access the data from the cloud server 108 through the communication network 106 and send information to the cloud server 108 through the communication network 106.

### CROSS-REFERENCE TO RELATED APPLICATIONS

This application claims benefit to U.S. Provisional Patent Application No. 61/719,089, filed Oct. 26, 2012, the disclosure of which is hereby incorporated by reference herein in its entirety.

### FIELD OF THE INVENTION

The present invention relates generally to telemedicine. More particularly, the present invention relates to a system and method for providing remote medical consulting between a patient and a physician.

### BACKGROUND OF THE INVENTION

The United States has seen an exponential increase in healthcare costs in the recent years and there has been a steady growth in the number of uninsured adults and children. The current health care delivery system is fragmented, impersonal and focused on high cost specialty care. In 2008, the United States spent over $2.3 trillion on healthcare, which is more than triple the 714 billion spent in 1990. The government, employers, and consumers are struggling to keep up with rising costs while at the same time providers try to improve the quality of health care. Coupled to this, there is a predicted shortage of health professionals which will accentuate the problems faced today and even in the future. The only solution to counter the current set of problems is to develop new paradigms of care that will lower costs, improve efficiency, increase access and improve quality of care for all.

Telemedicine is one of the solutions to address the aforesaid problems. Telemedicine is defined as the use of communication technologies to exchange medical information to provide remote delivery of clinical care. Telemedicine services can be delivered in live and interactive formats or asynchronously through store and forward mechanisms. Modern telemedicine systems support an integrated approach focused on disease prevention, chronic disease management, and decision support and also provide improved efficiencies, quality, patient safety and satisfaction.

The present invention aims to create an infrastructure where the concept of telemedicine is taken to the patient's home and can be effectively used to assess non-critical acute medical episodes in chronic patient care and in pediatrics and adult patients. The concept of telemedicine is used across all age group patients. The system promotes an ongoing relationship with a personal physician who is the first contact (as part of a team) for delivering efficient, continuous and comprehensive care as compared to traditional models followed today. For example one report estimates that around $18 billion spent due to un-necessary emergency room visits to the hospitals and studies from the National Center for Health Statistics found that as many as 55% of emergency room visits were not required. Unnecessary emergency room visits can cost billions of dollars. Further, patients have to wait for a longer period to consult their own physician due to unnecessary emergency room visits. The current system aims to reduce such inefficiencies and also enhances access to quality and personalized healthcare with the use of advanced communication and information technology while reducing overall cost of healthcare. The system adheres to the concepts laid down for the Patient Connected Medical Home (PCMH) which is a proven model to provide comprehensive care to patients and improve health and well-being.

Further, the present invention provides an optimized and efficient manner of consulting a personal physician as opposed to the existing fragmented health care availability. The present invention provides an improving significant quality of health care of the patient and improving satisfaction of the patient as compared to the existing systems. The present invention also provides an increasing systemic efficiency with open access scheduling, expanding working hours and achieving small turnaround times, increasing safety for the patient and reducing the liability on the physician as the system involves evidence based decision making and electronic medical record (EMR) integration, reducing cost per transaction for the patient and insurer, and easing the burden on over stressed emergency departments by reducing unnecessary visits.

### SUMMARY OF THE INVENTION

The present invention is a system and method for providing remote medical consulting between a patient and a physician. The system comprises a handheld patient device, a physician device, and a cloud server, connected through a public communication network, which is the Internet. The patient device is configured to receive data from the patient using a plurality of diagnostic sensors and send the data to the cloud server through the said communication network. The present system is scalable by adding diagnostic sensors on a need basis for diagnosing the indicatives of the biological activities of the patient. The physician device executes a physician application, which is embedded in the physician device. The physician device can be an off-the-shelf personal computer or mobile computing device. The physician device, which incorporates an application, is capable of receiving diagnostic data from the patient device and can access the data stored on the cloud server; send an electronic medical record to the cloud server through the communication network and store all the session data on the cloud server.

The present invention also comprises of a method for providing remote medical consulting between a patient and a physician, the method comprising the steps of: establishing a communication link between a patient device and a physician device through a cloud server on a public communication network, which is the Internet; collecting data from the patient using the patient device through a plurality of diagnostic sensors or video means or audio means; sending the data from the patient device to the cloud server through the said communication network; adding diagnostic sensors on a need basis for diagnosing the indicatives of the biological activities of the patient in order to make the system scalable; accessing the data from the cloud server, sending an electronic medical record to the cloud server through the communication network and store all the session data on the cloud server using the physician device incorporating an application. In this method, the insurance claims and treatment plan are sent via an electronic script.

The present invention can operate on two modes of communication, one being real time or online mode of communication and the other being a ‘store and forward’ mode or offline mode of communication.

### BRIEF DESCRIPTION OF THE DRAWINGS

These and other aspects, features and advantages of the invention will be better understood with reference to the following detailed description and the accompanying drawings, in which the same numerals indicate the same part and wherein:

FIG. 1 illustrates a block diagram of a system of the present invention;

FIG. 2 illustrates a block diagram of a patient device; and

FIG. 3 shows a basic architecture of a physician application.

### DETAILED DESCRIPTION OF THE INVENTION

In order to achieve the aforesaid and other objectives, according to the invention, a system and method for providing remote medical consulting between a patient and a physician is disclosed.

While system and method are described herein by way of example and embodiments, those skilled in the art recognize that system and method for providing remote medical consulting between a patient and a physician is not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As a preliminary matter, the definition of the term or for the purpose of the following discussion and the appended claims is intended to be an inclusive “or” That is, the term or is not intended to differentiate between two mutually exclusive alternatives. Rather, the term or when employed as a conjunction between two elements is defined as including one element by itself, the other element itself, and combinations and permutations of the elements. For example, a discussion or recitation employing the terminology “A” or “B” includes: “A” by itself, “B” by itself and any combination thereof, such as “AB” and/or “BA.” It is worth noting that the present discussion relates to exemplary embodiments, and the appended claims should not be limited to the embodiments discussed herein.

According to one embodiment of the invention, there is provided a system for providing remote medical consulting between a patient and a physician. The system comprises a patient device, a physician device, a cloud server wherein the patient device, the physician device and the cloud server are connected through a public communication network, which is the Internet. The patient device is configured to receive data from the patient using a plurality of diagnostic sensors and send the data to the cloud server through the communication network. The physician device executes a physician application, which is embedded in the physician device and the physician application is running on the physician device. The physician device can be an off-the-shelf personal computer or mobile computing device. The physician device, which incorporates an application, can access the data of the patient from patient device and the cloud server through the communication network, send an electronic medical record to the cloud server through the communication network and store all the session data on the cloud server. The stored data can't be edited by the physician later.

The patient device includes a sensor subsystem, a housing/casing, video means, audio means and a display unit. The sensor subsystem comprises a plurality of diagnostic sensors, which are adapted to be connected to the patient device in order to collect data from the patient. The data may be in the form of audio or video or text. The data may be a plurality of health parameters/measurements of the patient using at least one diagnostic sensor in the form of audio or video or text. The diagnostic sensors are either built into the device or connected.

The plurality of digital diagnostic sensors can be connected to the patient device using either wired or wireless means. These sensors can be used to monitor physical parameters indicated by the human body such as body temperature (using a digital thermometer), heart and lung sounds (using a digital stethoscope), arterial pressure (using a digital sphygmomanometer), volume of air inspired and expired by the lungs (using a digital spirometer), oxygen saturation (using a digital pulse oximeter) and electric activity of the heart (using a digital ECG apparatus). Furthermore a plurality of cameras can be used to capture images of the skin, the throat, the ear canal and the eye among other organs. The sensors can determine chemistry of bodily fluids such as blood and urine to determine levels of components such as sodium, potassium, chloride, bicarbonate, blood urea nitrogen, magnesium, creatinine, glucose, cholesterol and triglycerides. The lists above are only indicative and a wider range of digital sensors can be accommodated by the subsystem.

The display unit may be adapted to be located on the top surface of the patient device for displaying the data. The display unit is a touch screen having a user interface (UI), which is useful to the patients for easy operation of the patient device. It is capable of providing tutorials in the form of videos or presentations. The video or audio presentations guide the patients on how to use the patient device correctly and effectively. For example, during auscultation the physician may trigger specific images on the screen as to where the patient should hold the stethoscope so that the physician gets the best sounds. The microcontroller is configured to run an operating system which controls the various peripherals and subsystems.

The communication network is a local-area network (“LAN”), a wide-area network (“WAN”), the Internet, or any other networking topology known in the art that connects the patient device to the cloud server and also the physician device incorporating the application to the cloud server. The communication network is a public communication network, which is a wireless internet or wired internet or both.

The physician application is capable of operating out standard off-the-shelf devices such as a personal computer (laptops or desktops) or a smart phone/tablet computer with internet connectivity. It is assumed that the devices mentioned above, have display, video and audio capabilities to display the diagnostic information sent by the patient device.

The present invention provides the system for providing remote medical consulting between the patient and the physician, wherein the system is adapted to be flexible and scalable. The system can be customized according to a specific patient or a specific health problem. If the patient suffers from a specific chronic condition then a set of sensors to manage that chronic care can be prescribed for him effectively customizing the device to his needs. For example, if a patient has diabetes, the system can be customized in such a way that glucometer be used to know the glucose levels. Furthermore new low-cost sensors are being invented all the time and will continue to be invented. The system is capable of adapting and assimilating these new sensors and technologies dynamically (in runtime) because of the ability of the device to interface to these sensors using multiple and generic wired and wireless means and the possibility of upgrading the firmware in the device over-the-air.

The present invention can operate in two modes of communication, one being real time or online mode of communication and the other being a ‘store and forward’ mode or offline mode of communication.

In a real time or online mode of communication, a direct or peer-to-peer session is setup between the patient device and the physician using a session negotiation engine which is a part of the cloud services (since the patient and physician are online at the same time). The patient logs into the cloud server with the patient device and also the physician logs into the cloud server using the physician application. Once, the physician is online, the physician is presented with a list of his patients who are logged on. The physician selects the patient and picks up the electronic medical record from the cloud server using the physician application. The physician then begins a consultation with the patient and uses the diagnostic sensors to get various measurements/parameters of the indicatives of the biological activities of the patient. During the consultation session, the physician writes notes and prescriptions and then closes and locks the session. All the session data is stored on the cloud and archived so that they can be searched and retrieved in the future. The system is capable of supporting multiple simultaneous connections between many patient devices and doctor applications.

In ‘store and forward’ or ‘offline’ mode of communication, the patient selects a sensor and records the data from the sensors and stores the data on to the storage of the patient device itself. This data is then transferred to the cloud server when the patient device is connected to the network. Once the data is sent to the cloud server, the physician may get intimation through email or other means of communication that the data has been sent to the cloud server. Once the physician receives the intimation, the physician is able to review the data and take necessary action. The offline mode can also be used for continuous monitoring. For example, if a certain parameters such as blood pressure, temperature have to be sampled at regular intervals the patient device can be setup to measure the parameter automatically and upload it on the cloud. The physician at his free time can look at the data, which may be in the form of graphs so that he can get information about how that parameter is varying with time.

According to another embodiment of the invention, there is provided a method for providing remote medical consulting between a patient and a physician. The method comprising the steps of: establishing a communication link between a patient device and a physician device through a cloud server on a public communication network, which is the Internet; collecting data from the patient using the patient device through a plurality of diagnostic sensors or video means or audio means; sending the data from the patient device to the cloud server through the said communication network; adding diagnostic sensors on a need basis for diagnosing the indicatives of the biological activities of the patient in order to make the system scalable; accessing the data from the cloud server, sending an electronic medical record on the cloud server through the communication network and store all the session data on the cloud server using the physician device incorporating an application.

The patient himself can use the patient device for collecting the data such as indicatives of biological activities in the form of audio or video or text. There is no need of trained person or expert to operate the patient device. The patient device can also be operated by a caretaker or parent or any person with no medical background.

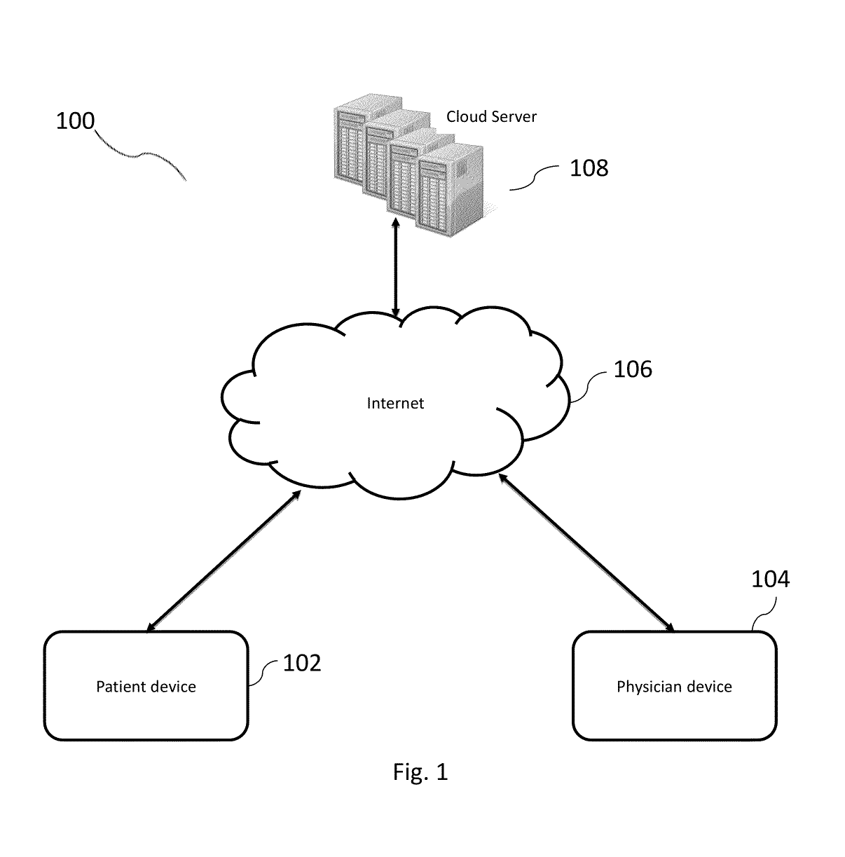

FIG. 1 shows a block diagram of the system 100 for providing remote medical consulting between the patient and the physician. The system comprises the patient device 102, the physician device incorporating an application 104, the public communication network 106, which is the internet and the cloud server 108, wherein the patient device 102, the physician device 104 and the cloud server 108 are connected through a public communication network 106, which is the Internet.

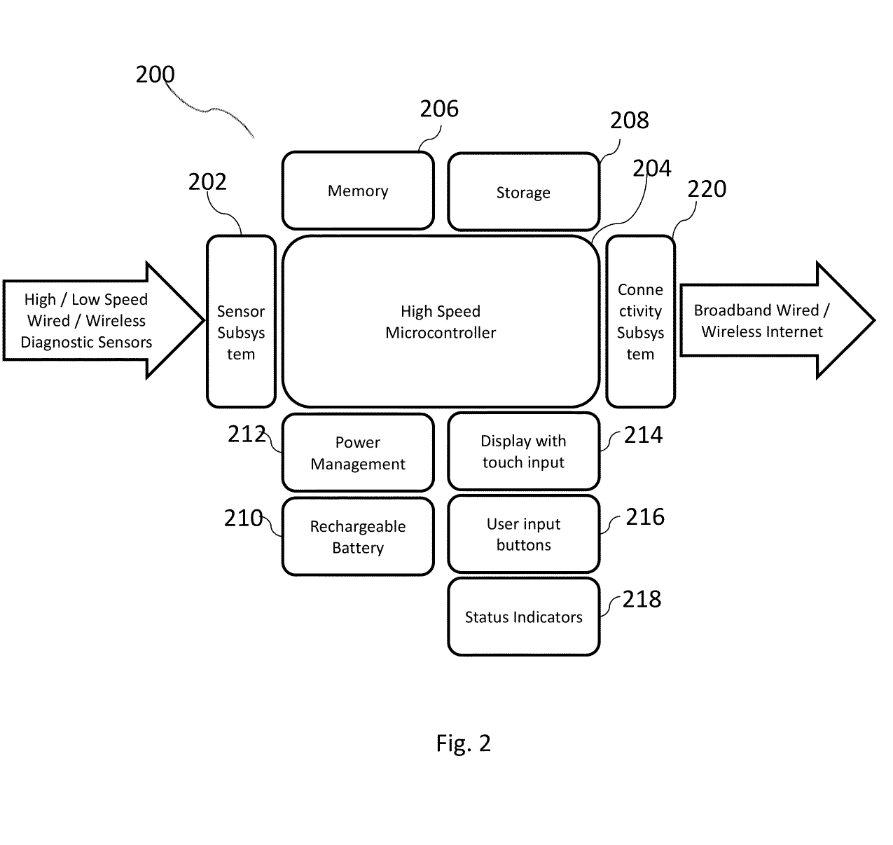

FIG. 2 shows a block diagram of the patient device. The patient device 102 comprises a sensor subsystem 202, a micro controller 204, memory 206, storage 208, a rechargeable battery 210, a power management module 212, a display with touch input 214, user input buttons 216, status indicators 218, and a connectivity subsystem 220. The patient device 102 is a portable handheld device which is a battery operated. The sensor subsystem 202 has various diagnostic sensors, which can be used for gathering information about the patient's health. Further the sensor subsystem 202 supports the data from wired or wireless sensors. It can also accept and process the data from audio and video sensors. The microcontroller 204 runs an operating system which controls the various peripherals and subsystems. Various applications within the operating system provide services to manage the sensors, process the data from the sensors, manage network connectivity and present the user interface.

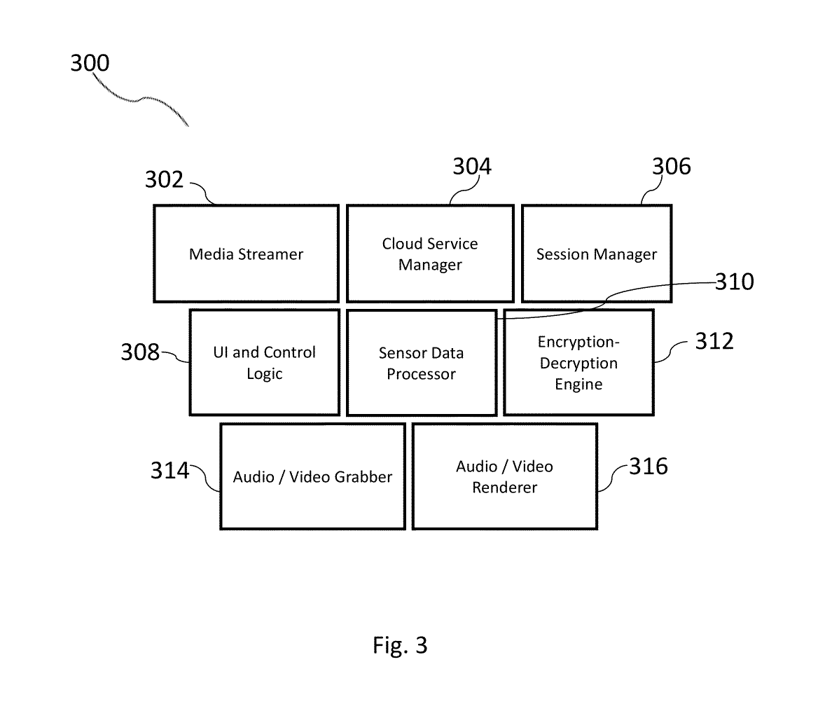

FIG. 3 shows a basic architecture 300 of the physician application. The physician application is a computer program capable of running on PCs and mobile devices such as smart phones and tablets which displays real-time and stored diagnostic information. The media streamer module 302 creates, maintains and manages a peer-to-peer low latency link between the patient device 102 and the physician device incorporating an application 104 for very low-latency real-time multimedia streams. The cloud service manager module 304 connects to the services on the cloud and provides billing, insurance, sessions notes, prescription and options to search and view stored consultations. The cloud services include session initiation and management services, session storage/retrieval, prescription management and audit trails. The session manager module 306 connects to a session negotiation engine on the server to provide session initialization and management service to connect a patient device 102 and the physician device incorporating the application 104 in a real time consultation session. The user interface (UI) and control logic module 308 provides a toolbox which allows the physician to choose the sensor needed for a diagnostic application and then displays the processed results retrieved from the sensor. The sensor data processor module 310 converts the data received from the sensors into information so as to read and analyze it in an easy way. The encryption-decryption engine module 312 provides a secured data transfer over the public communication network 106, which is the internet. The audio and video grabber module 314 picks up and compresses audio and video information from connected cameras and microphones. The audio and video renderer module 316 decompresses and renders the received audio and video streams.

While the present invention has been related in terms of the foregoing embodiments, those skilled in the art will recognize that the invention is not limited to the embodiments depicted. The present invention may be practiced with modification and alteration within the spirit and scope of the appended claims. Thus, the description is to be regarded as illustrative instead of restrictive on the present invention.

The detailed description is presented to enable a person of skill in the art to make and use the invention. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A system for providing remote medical consulting between a patient and a physician, said system comprising:
a) a patient device;
b) a physician device;
c) a cloud server;
d) said patient device, said cloud server and said physician device connected through a communication network;
e) said patient device configured to receive data from said patient using at least one diagnostic sensor and send said data on said cloud server through said communication network; and
f) said physician device configured to access said data from said cloud server through said communication network, and send information on said cloud server through said communication network.

2) The system as claimed in claim 1, wherein said patient device comprises:
a) a microcontroller operatively coupled to said patient device;
b) video means operatively coupled to said patient device;
c) said at least one diagnostic sensor adapted to connect to said patient device;
d) audio means operatively coupled to said patient device; and
e) a display unit;
f) wherein said video means or said audio means or said at least one diagnostic sensor is configured to collect said data from said patient; and said display unit is adapted for displaying said data.

3) The system as claimed in claim 1, wherein a physician application is embedded in said physician device.

4) The system as claimed in claim 1, wherein said patient device is adapted for accommodating at least one diagnostic sensor on a need basis for collecting said data from said patient in order to make said system customizable.

5) The system as claimed in claim 1, wherein said patient device is adapted for configuring a plurality of diagnostic sensors in order to make said system scalable.

6) The system as claimed in claim 1, wherein said data and said information is stored on said cloud server to be reviewed periodically.

7) The system as claimed in claim 1, wherein said at least one diagnostic sensor comprises: a digital thermometer, a digital otoscope, a digital ophthalmoscope, a digital spirometer, a digital stethoscope, a digital sphygmomanometer, a blood chemistry analyser, a digital pulse oximeter, a digital glucose meter or a digital electrocardiograph apparatus.

8) The system as claimed in claim 1, wherein said information is an electronic medical record.

9) The system as claimed in claim 1, further comprises a billing module.

10) The system as claimed in claim 1, further comprises an insurance claim module in order to claim insurance from an insurance company.

11) The system as claimed in claim 1, wherein said remote medical consulting between said patient and said physician is in real time.

12) A method for providing remote medical consulting between a patient and a physician, said method comprising the steps of:
a) establishing a communication link between a patient device and a physician device through a communication network via a cloud server;
b) collecting data from said patient using said patient device through at least one diagnostic sensor or video means or audio means;
c) sending said data from said patient device on said cloud server through said communication network;
d) accessing said data from said cloud server through said communication network using said physician device; and
e) sending information on said cloud server through said communication network using said physician device.

13) The method as claimed in claim 12, wherein said physician device executes a physician application embedded in said physician device.

14) The method as claimed in claim 12, wherein said information is an electronic medical record.

15) The method as claimed in claim 12, wherein diagnostic sensors are chosen on a need basis for collecting said data from said patient in order to make said system customizable.

16) The method as claimed in claim 12, wherein a plurality of diagnostic sensors are configured with said patient device in order to make said system scalable.

17) The method as claimed in claim 12, wherein said data and said information is stored on said cloud server to be reviewed periodically.

18) The method as claimed in claim 12, further comprising a billing module.

19) The method as claimed in claim 12, further comprising an insurance claim module in order to claim insurance from an insurance company.

20) The method as claimed in claim 12, wherein said remote medical consulting between said patient and said physician is in real time.
